(19) United States
(12) Patent Application Publication
(10) Pub. No.: US 2022/0064031 A1
(43) Pub. Date: Mar. 3, 2022

(54) HYBRID WATER TREATMENT SYSTEM FOR RED TIDE REMOVAL AND PERCHLORATE CONTROL AND WATER TREATMENT METHOD USING THE SAME

(71) Applicant: Korea University Research and Business Foundation, Seoul (KR)

(72) Inventors: Seungkwan HONG, Yongin-si (KR); Yong-Uk SHIN, Seoul (KR); Jihun LIM, Seongnam-si (KR)

(73) Assignee: Korea University Research and Business Foundation, Seoul (KR)

(21) Appl. No.: 17/389,673

(22) Filed: Jul. 30, 2021

(30) Foreign Application Priority Data
Aug. 31, 2020 (KR) 10-2020-0110222

(51) Int. Cl. C02F 1/461; C02F 1/467; C02F 1/469

(52) U.S. Cl. CPC C02F 1/46109; C02F 2103/08; C02F 1/4691; C02F 1/4674

(57) ABSTRACT

Disclosed is a hybrid water-treating system. The system includes a raw-water supply bath having a predetermined volume and configured to receive raw-water containing high concentration organic contaminants; at least one electrolytic bath configured to receive the raw-water supplied from the raw-water supply bath and to produce first treated water, wherein a boron doped diamond (BDD) electrode is installed in the electrolytic bath; and at least one deionization bath configured to receive the first treated water discharged from the electrolytic bath and to produce second treated water, wherein flow-electrode capacitive deionization (FCDI) is performed when applying a first voltage to the deionization bath.

### CROSS-REFERENCE TO RELATED APPLICATION

This application claims a benefit under 35 U.S.C. § 119(a) of Korean Patent Application No. 10-2020-0110222 filed on Aug. 31, 2020, on the Korean Intellectual Property Office, the entirety of disclosure of which is incorporated herein by reference for all purposes.

### BACKGROUND

### Field

The present disclosure relates to a hybrid water-treating system for red tide removal and perchlorate control and a water treatment method using the same. More specifically, the present disclosure relates to a hybrid water-treating system that may efficiently control red tide removal and perchlorate while being subjected to restrictions on environmental conditions, using electrolytic oxidation and flow-electrode capacitive deionization, and to a water treatment method using the same.

### Description of Related Art

Red tides occur frequently in coastal areas where population are concentrated around the world due to industrial development. In Korea, a red tide is occurring on a southern coast where an aquaculture industry is concentrated due to diversification of contaminants and improvement of living standards due to economic growth.

There are physical, chemical, and biological methods for red tide control. Specifically, there are a chemical spraying method, an ultrasonic treatment method, an ozone treatment method, a bio-control method, etc. which that may destroy and kill red tide organisms. However, these methods may not be easily applied in terms of treatment speed, economy, and secondary environmental pollution.

Therefore, various studies for red tide removal that do not cause the secondary environmental pollution and may be easily applied industrially are being conducted.

A related prior art is disclosed in Korean Patent No. 10-1627642 (May 31, 2016).

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter.

A purpose of the present disclosure is to provide a hybrid water-treating system that may carry out red tide removal and perchlorate control at high efficiency, and may be compactable and have excellent space utilization, and provide a water treatment method using the same.

Further, another purpose of the present disclosure is to provide a hybrid water-treating system which may carry out red tide removal and perchlorate control using electrolytic oxidation without adding a separate salt from an outside thereto, and may control red tide and organic contaminants contained in sea-water while not generating secondary contaminants, and to provide a water treatment method using the same.

One aspect of the present disclosure provides a hybrid water-treating system comprising: a raw-water supply bath having a predetermined volume and configured to receive raw-water containing high concentration organic contaminants; at least one electrolytic bath configured to receive the raw-water supplied from the raw-water supply bath and to produce first treated water, wherein a boron doped diamond (BDD) electrode is installed in the electrolytic bath; and at least one deionization bath configured to receive the first treated water discharged from the electrolytic bath and to produce second treated water, wherein flow-electrode capacitive deionization (FCDI) is performed when applying a first voltage to the deionization bath.

In one implementation of the system, the system further comprises: a first treated water connection channel for connecting the electrolytic bath and the deionization bath to each other, wherein a pump for delivering the first treated water is installed in the first treated water connection channel; and a storage bath for receiving the second treated water from the deionization bath and storing the second treated water therein. In one implementation of the system, the raw-water includes sea-water containing sodium chloride (NaCl) at a concentration of 0.3M to 1.0M, wherein the first treated water contains perchlorate at a first concentration, wherein the second treated water contains perchlorate at a second concentration, wherein the second concentration is lower than or equal to 0.3 times of the first concentration.

In one implementation of the system, the first voltage is in a range of 0.6V to 1.2V.

In one implementation of the system, the deionization bath includes: a negative electrode including activated carbon particles; a positive electrode facing toward and spaced from the negative electrode; and at least one ion exchange membrane disposed between the negative electrode and the positive electrode, wherein the activated carbon particles have been subjected to ultrasonication for 3 to 10 hours, wherein the activated carbon particle has a particle diameter of 1 ᵢm to 150 gm, and a specific surface area of 1500 m²/g to 1600 m²/g.

In one implementation of the system, the negative electrode has a plate shape, and the positive electrode has a plate shape having a size corresponding to a size of the negative electrode, wherein the at least one ion exchange membrane includes a first membrane adjacent to the positive electrode, and a second membrane adjacent to the negative electrode, and spaced apart from the first membrane, wherein while the first treated water passes through a flow path defined between the first and second membranes, the first treated water is converted into the second treated water.

In one implementation of the system, the electrolytic bath further includes a counter electrode facing toward the boron doped diamond electrode, wherein the counter electrode is made of at least one of titanium (Ti), zirconium (Zr), or platinum (Pt).

In one implementation of the system, the system further comprises a power supply electrically connected to the deionization bath, wherein the power supply include a solar cell for collecting solar energy and converting the solar energy into electric energy, wherein the power supply supplies the electrical energy to the deionization bath.

In one implementation of the system, the raw-water includes sea-water, and the system is used for sea-water desalination.

Another aspect of the present disclosure provides a hybrid water-treating method comprising: providing an electrolytic bath in which a boron doped diamond electrode is installed; introducing raw-water containing red tide into the electrolytic bath; applying a current to the electrode to produce first treated water; delivering the first treated water to a deionization bath in which flow-electrode capacitive deionization (FCDI) is performed; and applying a first voltage to the deionization bath to produce second treated water.

In one implementation of the method, the raw-water includes sea-water containing sodium chloride (NaCl) at a concentration of 0.3M to 1.0M, wherein the first treated water contains perchlorate at a first concentration, wherein the second treated water contains perchlorate at a second concentration, wherein the second concentration is lower than or equal to 0.3 times of the first concentration.

In one implementation of the method, the first voltage is in a range of 0.6V to 1.2V.

In one implementation of the method, the deionization bath includes: a negative electrode including activated carbon particles; a positive electrode facing toward and spaced from the negative electrode; and at least one ion exchange membrane disposed between the negative electrode and the positive electrode, wherein the activated carbon particles have been subjected to ultrasonication for 3 to 10 hours, wherein the activated carbon particle has a particle diameter of 1 μm to 150 μm, and a specific surface area of 1500 m²/g to 1600 m²/g.

In one implementation of the method, the negative electrode has a plate shape, and the positive electrode has a plate shape having a size corresponding to a size of the negative electrode, wherein the at least one ion exchange membrane includes a first membrane adjacent to the positive electrode, and a second membrane adjacent to the negative electrode, and spaced apart from the first membrane, wherein while the first treated water passes through a flow path defined between the first and second membranes, the first treated water is converted into the second treated water.

In one implementation of the method, the electrolytic bath further includes a counter electrode facing toward the boron doped diamond electrode, wherein the counter electrode is made of at least one of titanium (Ti), zirconium (Zr), or platinum (Pt).

According to the present disclosure as discussed above, the hybrid water-treating system and the water treatment method using the same for red tide removal and perchlorate control may be realized which may effectively remove red tide and contaminants contained in sea-water and simultaneously convert sea-water to fresh water.

Further, according to the present disclosure, the hybrid water-treating system and the water treatment method using the same for red tide removal and perchlorate control may be realized which may be efficiently used for sea-water contaminated with red tide and high concentration organic contaminants contained in the sea-water for a long time, and which may generate an oxidizing agent without adding a separate chemical thereto.

### BRIEF DESCRIPTION OF DRAWINGS

FIG. 1 is a diagram schematically showing a hybrid water-treating system according to one embodiment of the present disclosure.

FIG. 2 schematically shows an electrolytic bath and a deionization bath of FIG. 1.

FIG. 3 is a diagram schematically showing a hybrid water-treating system according to another embodiment of the present disclosure.

FIG. 4 is a flowchart showing a hybrid water-treating method according to one embodiment of the present disclosure.

FIG. 5 is a graph identifying red tide decomposition efficiency in an electrolytic bath using a solution containing red tide.

FIG. 6 is a graph identifying decomposition efficiency of organic contaminants in an electrolytic bath using a solution including humic acid and alginate.

FIG. 7 is a graph showing toxic by-products contained in a solution treated in the electrolytic bath.

FIG. 8 is a photograph showing before and after ultrasonication of activated carbon contained in the deionization bath according to an embodiment of the present disclosure.

FIG. 9 is a graph identifying an ion removal percentage in the deionization bath.

FIG. 10 is a graph showing a salt adsorption capacity and a salt adsorption rate in the deionization bath.

### DETAILED DESCRIPTIONS

For simplicity and clarity of illustration, elements in the drawings are not necessarily drawn to scale. The same reference numbers in different drawings represent the same or similar elements, and as such perform similar functionality. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure. Examples of various embodiments are illustrated and described further below. It will be understood that the description herein is not intended to limit the claims to the specific embodiments described. On the contrary, it is intended to cover alternatives, modifications, and equivalents as may be included within the spirit and scope of the present disclosure as defined by the appended claims.

A shape, a size, a ratio, an angle, a number, etc. disclosed in the drawings for describing an embodiments of the present disclosure are exemplary, and the present disclosure is not limited thereto. The same reference numerals refer to the same elements herein. Further, descriptions and details of well-known steps and elements are omitted for simplicity of the description. Furthermore, in the following detailed description of the present disclosure, numerous specific details are set forth in order to provide a thorough understanding of the present disclosure. However, it will be understood that the present disclosure may be practiced without these specific details. In other instances, well-known methods, procedures, components, and circuits have not been described in detail so as not to unnecessarily obscure aspects of the present disclosure.

The terminology used herein is for the purpose of describing particular embodiments only and is not intended to limit the present disclosure. As used herein, the singular forms “a” and “an” are intended to include the plural forms as well, unless the context clearly indicates otherwise. It will be further understood that the terms “comprises”, “comprising”, “includes”, and “including” when used in this specification, specify the presence of the stated features, integers, operations, elements, and/or components, but do not preclude the presence or addition of one or more other features, integers, operations, elements, components, and/or portions thereof. As used herein, the term “and/or” includes any and all combinations of one or more of the associated listed items. Expression such as “at least one of” when preceding a list of elements may modify the entirety of list of elements and may not modify the individual elements of the list. When referring to “C to D”, this means C inclusive to D inclusive unless otherwise specified.

It will be understood that, although the terms “first”, “second”, “third”, and so on may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

In addition, it will also be understood that when a first element or layer is referred to as being present “on” or “beneath” a second element or layer, the first element may be disposed directly on or beneath the second element or may be disposed indirectly on or beneath the second element with a third element or layer being disposed between the first and second elements or layers. It will be understood that when an element or layer is referred to as being “connected to”, or “coupled to” another element or layer, it may be directly on, connected to, or coupled to the other element or layer, or one or more intervening elements or layers may be present. In addition, it will also be understood that when an element or layer is referred to as being “between” two elements or layers, it may be the only element or layer between the two elements or layers, or one or more intervening elements or layers may also be present.

Further, as used herein, when a layer, film, region, plate, or the like is disposed “on” or “on a top” of another layer, film, region, plate, or the like, the former may directly contact the latter or still another layer, film, region, plate, or the like may be disposed between the former and the latter. As used herein, when a layer, film, region, plate, or the like is directly disposed “on” or “on a top” of another layer, film, region, plate, or the like, the former directly contacts the latter and still another layer, film, region, plate, or the like is not disposed between the former and the latter. Further, as used herein, when a layer, film, region, plate, or the like is disposed “below” or “under” another layer, film, region, plate, or the like, the former may directly contact the latter or still another layer, film, region, plate, or the like may be disposed between the former and the latter. As used herein, when a layer, film, region, plate, or the like is directly disposed “below” or “under” another layer, film, region, plate, or the like, the former directly contacts the latter and still another layer, film, region, plate, or the like is not disposed between the former and the latter.

Unless otherwise defined, all terms including technical and scientific terms used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In one example, when a certain embodiment may be implemented differently, a function or operation specified in a specific block may occur in a sequence different from that specified in a flowchart. For example, two consecutive blocks may actually be executed at the same time. Depending on a related function or operation, the blocks may be executed in a reverse sequence.

In descriptions of temporal relationships, for example, temporal precedent relationships between two events such as “after”, “subsequent to”, “before”, etc., another event may occur therebetween unless “directly after”, “directly subsequent” or “directly before” is not indicated. The features of the various embodiments of the present disclosure may be partially or entirely combined with each other, and may be technically associated with each other or operate with each other. The embodiments may be implemented independently of each other and may be implemented together in an association relationship. Spatially relative terms, such as “beneath,” “below,” “lower,” “under,” “above,” “upper,” and the like, may be used herein for ease of explanation to describe one element or feature's relationship to another element or feature as illustrated in the figures. It will be understood that the spatially relative terms are intended to encompass different orientations of the device in use or in operation, in addition to the orientation depicted in the figures. For example, when the device in the drawings is turned over, elements described as “below” or “beneath” or “under” other elements or features would then be oriented “above” the other elements or features. Thus, the example terms “below” and “under” may encompass both an orientation of above and below. The device may be otherwise oriented for example, rotated 90 degrees or at other orientations, and the spatially relative descriptors used herein should be interpreted accordingly.

Unless otherwise specified in following descriptions, all of numbers, values, and/or expressions indicating ingredients, reaction conditions, and contents of ingredients in the present disclosure are, in essence, approximations thereof based on various uncertainties in measurements which occur in obtaining the numbers, values, and/or expressions. Thus, the numbers, values and/or expressions should be understood as being modified by a term “about” in all instances. Further, where a numerical range is disclosed in the present description, the range is continuous and includes a minimum value and a maximum value of the range, unless otherwise indicated. Further, where the number or the value refers to an integer, the range includes all of integers included between the minimum and the maximum of the range, unless otherwise indicated.

Further, in the present disclosure, when a variable is included in a range, the variable will be understood to include all values within a stated range including stated endpoints of the range. For example, a range of “5 to 10” includes values of 5, 6, 7, 8, 9, and 10, as well as any subranges such as 6 to 10, 7 to 10, 6 to 9, 7 to 9, etc. It will be understood that the variable includes any value between valid integers in a stated range such as 5.5, 6.5, 7.5, 5.5 to 8.5, and 6.5 to 9, etc. For example, a range “10% to 30%” includes all of integer values such as 10%, 11%, 12%, 13%, 30%, etc. as well as any subranges such as 10% to 15%, 12% to 18%, or 20% to 30%, etc. It will be understood that the range includes any value between valid integers within the stated range such as 10.5%, 15.5%, 25.5%, etc.

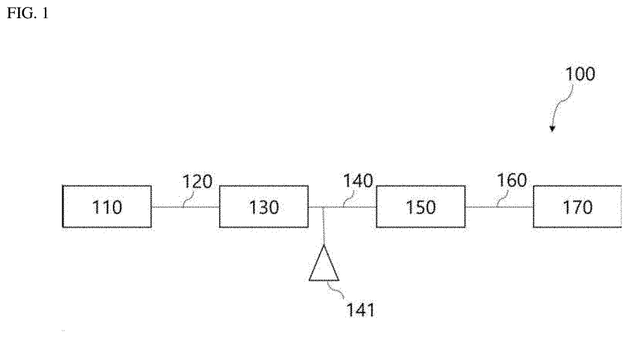

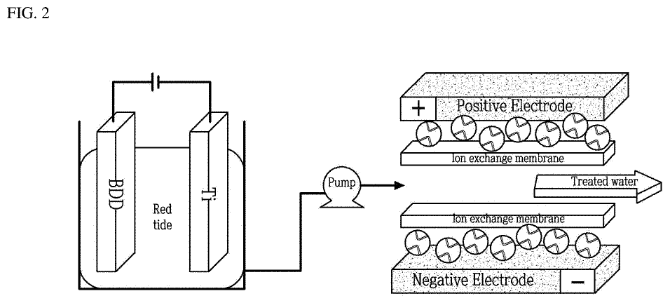

FIG. 1 is a diagram schematically showing a hybrid water-treating system according to one embodiment of the present disclosure, and FIG. 2 is a diagram schematically showing an electrolytic bath and a deionization bath of FIG. 1.

A hybrid water-treating system 100 according to one embodiment of the present disclosure may include a raw-water supply bath 110, a raw-water connection channel 120, an electrolytic bath 130, a first treated water connection channel 140, a deionization bath 150, a second treated water connection channel 160, and a storage bath 170.

The raw-water supply bath 110 has a predefined volume, and contains raw-water containing high concentration organic contaminant The electrolytic bath 130 may include at least one electrolytic bath. Raw-water supplied from the raw-water supply bath 110 is introduced into the electrolytic bath 130. A boron doped diamond (BDD) electrode may be installed in the electrolytic bath 130. The deionization bath 150 may include at least one deionization bath. First treated water discharged from the electrolytic bath 130 may be input to the deionization bath 150. Flow-electrode capacitive deionization (FCDI) may be performed in the deionization bath 150 by applying a first voltage thereto.

The raw-water supply bath 110 delivers the raw-water to the electrolytic bath 130 through the raw-water connection channel 120. The first treated water prepared in the electrolytic bath 130 may be transferred to the deionization bath 150 through the first treated water connection channel 140. The second treated water prepared in the deionization bath 150 may be transferred to the storage bath 170 through the second treated water connection channel 160. Then, the second treated water in the storage bath 170 may be converted into fresh water.

In the hybrid water-treating system 100 according to the present embodiment, the raw-water may include sea-water. Thus, the hybrid water-treating system 100 may be used for sea-water desalination. For example, when the raw-water is sea-water, the second treated water may be additionally treated in the storage bath 170 to produce fresh water or may be converted to fresh water without additional treatment.

The raw-water supply bath 110 may contain raw-water containing high concentration organic contaminant. The raw-water supply bath 110 may be provided in a form of a tank to have a predefined volume. A stirrer that stirs the raw-water, such as an impeller is provided therein to prevent contaminants contained in the raw-water from being deposited on a bottom of the raw-water supply bath 110 and to ensure that an overall concentration of the raw-water is uniform, such that the raw-water treatment in the electrolytic bath 130 may be performed efficiently.

The raw-water connection channel 120 may deliver raw-water prepared in the raw-water supply bath 110 to the electrolytic bath 130. The raw-water connection channel 120 may be formed integrally with the electrolytic bath 130 or may be detachable from or coupled to the electrolytic bath 130. The raw-water connection channel 120 may further contain a membrane in a form of a sieve. Thus, solid foreign substances contained in the raw-water may be filtered out through the sieve. Then, the filtered raw-water may be delivered to the electrolytic bath 130.

The electrolytic bath 130 may include the boron doped diamond electrode and a counter electrode facing toward the boron doped diamond electrode. The counter electrode may be made of at least one metal of titanium (Ti), zirconium (Zr), or platinum (Pt).

The boron doped diamond electrode may act as a positive electrode or an anode, and the counter electrode may act as a negative electrode or a cathode.

The boron doped diamond (BDD) electrode may be a kind of an insoluble electrode and may oxidize the organic contaminants contained in the raw-water. Further, the BDD electrode may have a wide potential window, and may have strong resistance to activity degradation caused by contamination of the electrode surface and have very strong electrochemical stability, thereby effectively treating the organic contaminants contained in the raw-water. The BDD electrode may be manufactured on a substrate made of silicon or a valve metal (Ti, Zr, Nb, Ta, etc.) using chemical vapor deposition (CVD).

In the electrolytic bath 130, the BDD electrode may be provided in a plate shape. The counter electrode may be provided in a plate shape having a size corresponding to that of the BDD electrode and may be electrically connected thereto. The BDD electrode and the counter electrode may be spaced from each other by a spacing of approximately 1 mm to 5 mm in the electrolytic bath 130. After the raw-water is added to the electrolytic bath 130, an electric current may be applied thereto, such that the organic contaminants in the raw-water may be effectively removed without chemical injection.

In the hybrid water-treating system 100 according to the present embodiment, the BDD electrode has a wide potential window. Thus, in a process of electrolyzing the raw-water, salt ions may be converted into various salt compounds such as ClO²⁻, ClO³⁻, ClO⁴⁻, etc. In this connection, the first treated water contains a high concentration of contaminants such as the salt compounds. In particular, perchlorate of ClO⁴⁻ may be problematic as it contains toxic by-products. On the contrary, the deionization bath 150 may effectively adsorb secondary pollutants such as perchlorate contained in the first treated water via electro-adsorption using flow-electrode capacitive deionization.

That is, in the hybrid water-treating system 100 according to the present embodiment, the BDD electrode in the electrolytic bath 130 may effectively remove the organic contaminants such as red tide to prepare the first treated water containing the salt compound such as perchlorate, and subsequently, the deionization bath 150 may adsorb and remove the perchlorate, etc. contained in the first treated water to prepare the second treated water. When the raw-water is sea-water, the second treated water may be converted into fresh water.

The first treated water connection channel 140 may connect the electrolytic bath 130 and the deionization bath 150 to each other and may have a pump 14 to deliver the first treated water. In the first treated water connection channel 140 , the pump 141 may control an amount of the first treated water flowing into the deionization bath 150. Further, the first treated water connection channel 140 may further contain therein a flow rate controller to control a flow rate of the first treated water.

The first treated water connection channel 140 may be embodied as a hollow pipe. The flow rate controller may be embodied as a plate inside the first treated water connection channel 140 to block an inside of the pipe step by step. The flow rate controller may control an amount of the first treated water passing therethrough while the pump 141 may control a flow speed of the first treated water at the same time. Further, the flow rate controller may be configured to completely block the first treated water connection channel 140. For example, a process occurring between the electrolytic bath 130 and the deionization bath 150 may be performed in a continuous process form or in a form of a batch process, depending on a blocking degree at which the flow rate controller blocks a flow path of the first treated water inside the first treated water connection channel 140.

When the first voltage is applied to the deionization bath 150, the deionization bath 150 may convert the first treated water to the second treated water using flow-electrode capacitive deionization. The flow-electrode capacitive deionization may remove ions via a process of adsorption and desorption of the ions onto or from a surface of a charged electrode using electrostatic attraction. In the flow-electrode capacitive deionization, an electric charge within an overpotential that may cause water decomposition may be applied to an activated carbon electrode. Thus, an electrical double layer may be formed on each of two temporarily charged electrodes, such that the ions are adsorbed thereto and thus are removed from a solution. Further, the ions adsorbed on the electrode surface undergo a desorption process by shorting the electrode or applying a reverse potential.

The deionization bath 150 may include a negative electrode including activated carbon provided in a particle form, a positive electrode facing toward the negative electrode and spaced apart from the negative electrode, and one or more ion exchange membranes provided between the negative electrode and the positive electrode. The activated carbon particles may be subjected to ultrasonication for 3 to 10 hours. A particle made of the activated carbon may have a particle diameter of 1 μm to 150 μm, and a specific surface area of 1500 m²/g to 1600 m²/g.

The activated carbon particles may be uniformly dispersed via the ultrasonication. Specifically, stirring may be performed at room temperature for 24 hours using a magnetic stirrer bar, followed by ultrasonication for 240 minutes. Thus, performance of the negative electrode using the activated carbon may be further improved.

The activated carbon may be subjected to the ultrasonication for 3 to 10 hours. The ultrasonication may allow the surface of the activated carbon to be modified, and allow agglomeration between the activated carbon particles to be prevented. The deionization bath 150 may adsorb more effectively the salt compounds such as perchlorate contained in the first treated water.

Further, the activated carbon particle may have a particle diameter of 1 μm to 150 μm, and a specific surface area of 1500 m²/g to 1600 m²/g. For example, the activated carbon particle may have a particle diameter of approximately 50 μm to 150 μm, or 50 μm to 130 μm, or 70 μm to 150 μm, or 70 μm to 130 μm, or 85 μm to 100 μm. The specific surface area of the activated carbon particle may be approximately 1520 m²/g to 1600 m²/g, or 1550 m²/g to 1600 m²/g, or 1570 m²/g to 1590 m²/g.

When the activated carbon particle has the particle diameter and the specific surface area in the above-mentioned ranges, the activated carbon particles may efficiently adsorb and then desorb the salt compound such as perchlorate contained in the first treated water, thereby converting the first treated water into the second treated water from which the perchlorate has been removed.

As described above, the deionization bath according to the present embodiment may include the negative electrode and the positive electrode. The negative electrode may be provided in a plate shape, and the positive electrode may be provided in a plate shape having a size corresponding to that of the negative electrode. The ion exchange membrane may be composed of a first membrane adjacent to the positive electrode, and a second membrane spaced apart from the first membrane and adjacent to the negative electrode. Further, the first treated water may be converted into the second treated water while the first treated water passes through a flow path defined between the first and second membranes.

When applying the first voltage to the negative and positive electrodes of the deionization bath 150, a desalination process may be performed. The first voltage may be in a range of 0.6V to 1.2V. When the first voltage is within the above range, the adsorption of perchlorate ions in the first treated water may proceed efficiently.

When the raw-water is sea-water, the hybrid water-treating system 100 according to the present embodiment may effectively remove the red tide from the sea-water, and may produce fresh water that does not contain toxic substances such as perchlorate.

The raw-water includes sea-water containing sodium chloride (NaCl) at a concentration of 0.3M to 1.0M. The first treated water contains perchlorate at a first concentration. The second treated water contains perchlorate at a second concentration. The second concentration may be lower than or equal to 0.3 times of the first concentration. Specifically, the second treated water may be prepared in a state in which more than 70% of the perchlorate contained in the first treated water is removed.

In the hybrid water-treating system 100, salts contained in the sea-water as a medium may be used without receiving additional salt from an outside. More specifically, the electrolytic bath 130 including the boron-doped diamond electrode as an electrocatalyst may induce active chlorine species such as HOCl, OCl⁻ as one of oxidizing agents using the salts contained in the sea-water as the medium. Thus, the red tide may be removed from the sea water, and the first treated water from which various organic contaminants are removed may be prepared. Further, the deionization bath 150 may remove ClO⁴⁻ ions as the toxic by-products contained in the first treated water via electrical adsorption and desorption. In this way, the sea-water may be converted into the fresh water.

Conventionally, various advanced oxidation processes and membranes (e.g., MF and UF) processes were introduced to treat the sea-water contaminated with the red tide, and high concentration organic contaminants (alginate, humic acid) contained in the sea-water. However, economic feasibility thereof was not achieved.

On the contrary, the hybrid water-treating system 100 according to the present embodiment may effectively remove the red tide contained in the sea-water even when the hybrid water-treating system 100 operates for a long time. The hybrid water-treating system 100 may generate an oxidizing agent without using a separate chemical, thereby reducing a chemical cost, and effectively desalinating the sea-water.

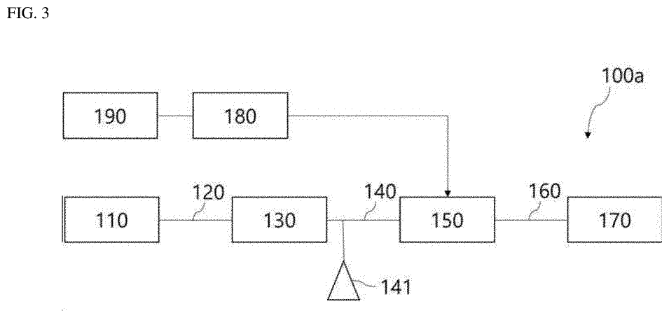

FIG. 3 is a diagram schematically showing a hybrid water-treating system according to another embodiment of the present disclosure.

A hybrid water-treating system 100a according to the present embodiment further includes a power supply 180 including a solar cell that collects sunlight and converts the solar energy into electric energy. The power supply 180 may supply the electrical energy to the deionization bath 150.

The hybrid water-treating system 100a according to the present embodiment may use the raw-water as the sea-water, and thus may be used in a large space where sunlight is strong. In this connection, when the power supply 180 including the solar cell is further included in the hybrid water-treating system 100a, the energy obtained by the solar cell may be delivered to the deionization bath 150, such that energy efficiency may be further improved.

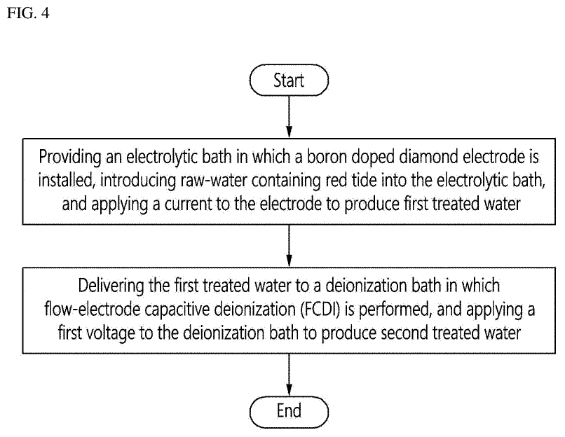

FIG. 4 is a flowchart showing a hybrid water-treating method according to one embodiment of the present disclosure.

Referring to FIG. 4, the hybrid water-treating method according to one embodiment of the present disclosure may include inputting the raw-water containing the red tide was into the electrolytic bath in which the boron doped diamond electrode is installed; preparing the first treated water by applying a current to the electrode; delivering the first treated water to the deionization bath in which the flow-electrode capacitive deionization (FCDI) is performed; and preparing the second treated water by applying the first voltage to the deionization bath.

In the hybrid water-treating method, the raw-water includes the sea-water containing the sodium chloride (NaCl) at a concentration of 0.3M to 1.0M. The first treated water contains perchlorate at the first concentration. The second treated water contains perchlorate at the second concentration. The second concentration may be lower than or equal to 0.3 times of the first concentration.

For example, the hybrid water-treating method may treat the raw-water such as the sea-water containing the organic contaminants such as the red tide via a continuous process and may convert the treated raw-water into the fresh water.

The boron doped diamond electrode may be installed in the electrolytic bath to effectively remove the organic contaminant from the raw-water. However, the perchlorate is created therein. Thus, perchlorate at the first concentration may be contained in the first treated water. Then, the deionization bath nay remove the perchlorate from the first treated water. Thus, the second treated water may contain the perchlorate at the second concentration. For example, the concentration of the perchlorate contained in the second treated water may be lower than or equal to 0.3 times of the perchlorate concentration in the first treated water. Specifically, the concentration of the perchlorate contained in the second treated water may be about 0.01 times to 0.3 times, or 0.01 times to 0.28 times of the perchlorate concentration in the first treated water.

The first voltage applied to the deionization bath may be in a range of 0.6V to 1.2V. Further, the deionization bath may include the negative electrode including the activated carbon provided in the particle form, the positive electrode facing toward and spaced from the negative electrode, and at least one ion exchange membrane disposed between the negative electrode and the positive electrode. The activated carbon particles may be subjected to the ultrasonication for 3 to 10 hours. The activated carbon particle may have a particle diameter of 1 μm to 150 μm, and a specific surface area of 1500 m²/g to 1600 m²/g.

Hereinafter, present examples and comparative examples of the present disclosure are described. However, each of the following examples is only one preferred implementation of the present disclosure, and the scope of the right of the present disclosure is not limited to the following examples.

1. Evaluation of Red Tide Decomposition using Electrolytic Bath

We prepares a solution having a concentration of 0.6M and 1L of NaCl as sea-water salt (Instant Ocean Sea Salt). Red tide was cultured for 5 days using algae culture conditions [light-dark cycle 10 hr: 14 hr/20° C.]. It could be identified that algae were formed at 17 cells/ml in the solution after the culture.

We put the solution containing the algae into the electrolytic bath (see FIG. 2) equipped with the boron doped diamond (BDD) and the titanium (Ti) electrode as the counter electrode. We applied an electric current to the electrodes without adding additional chemicals as follows. Thus, red tide decomposition efficiency was identified.

Electrolytic oxidation conditions in the electrolytic bath

Constant current mode

Current density: 300 mA/cm²

Anode: BDD (2 cm×5 cm)

Cathode: Ti (2 cm×5 cm)

Anode-cathode spacing: 1 cm

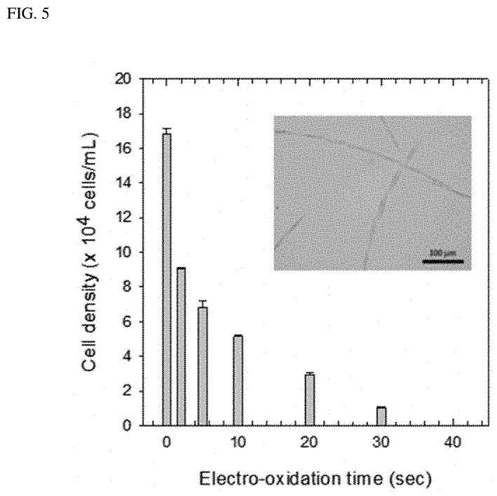

FIG. 5 is a graph identifying red tide decomposition efficiency in an electrolytic bath using a solution containing red tide. Referring to FIG. 5, it was identified that an entirety of the red tide was removed from the solution in approximately 40 seconds. Thus, it could be identified that the red tide could be removed during the electrolytic oxidation using the 2-electrode system using BDD and Ti.

2. Evaluation of Organic Contaminant Decomposition using Electrolytic Bath

We prepared a solution having a concentration of 0.6M and 1L of NaCl as sea-water salt (Instant Ocean Sea Salt). Each of humic acid and alginate was added thereto at 1000 mg/L. We put the solution containing humic acid and alginic acid into the electrolytic bath (see FIG. 2) equipped with the BDD electrode and the titanium (Ti) electrode under following conditions. We applied an electric current to the electrodes under the following conditions without adding additional chemicals. The decomposition efficiency was identified

Electrolytic oxidation conditions in the electrolytic bath

Constant current mode

Current density: 300 mA/cm²

Anode: BDD (2 cm×5 cm)

Cathode: Ti (2 cm×5 cm)

Anode-cathode spacing: 1 cm

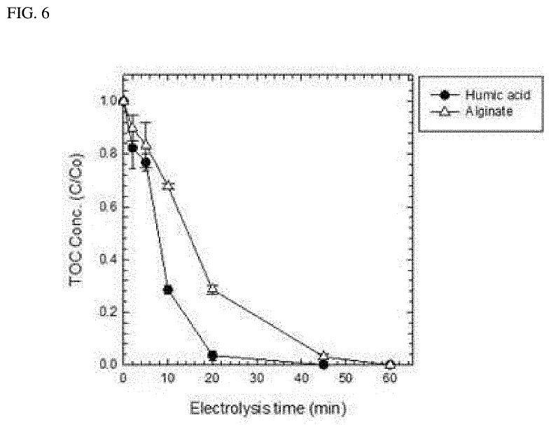

FIG. 6 is a graph identifying the decomposition efficiency of organic contaminants in the electrolytic bath using the solution containing humic acid and alginate. Referring to FIG. 6, it was identified that humic acid was decomposed faster than alginate is, but both aducic acid and alginate were decomposed in approximately 60 minutes. That is, it could be identified that when using the BDD electrode according to the present example, the high concentration organic contaminant present in the sea-water may be removed via electrolytic oxidation in the electrolytic bath.

3. Evaluation of Toxic by-Products After Electrolysis using an Electrolytic Bath

We added ammonia into ultrapure water. Then, an ammonia solution containing highly concentrated organic matter at an ammonia concentration of 4000 mg/L was prepared. We added ammonia and phenol into ultrapure water. Then, an ammonia/phenol solution containing organic matter of a high concentration at ammonia concentration of 4000 mg/L, and phenol concentration of 10 mM was prepared. We inputted each of the prepared ammonia solution and ammonia/phenol solution into the electrolytic bath as shown in FIG. 2. Then, electrolytic oxidation was carried out by applying an electric current thereto for 120 under the following conditions.

Electrolytic oxidation conditions in the electrolytic bath

Constant current mode

Current density: 300 mA/cm²

Anode: BDD (2 cm×5 cm)

Cathode: Ti (2 cm×5 cm)

Anode-cathode spacing: 1 cm

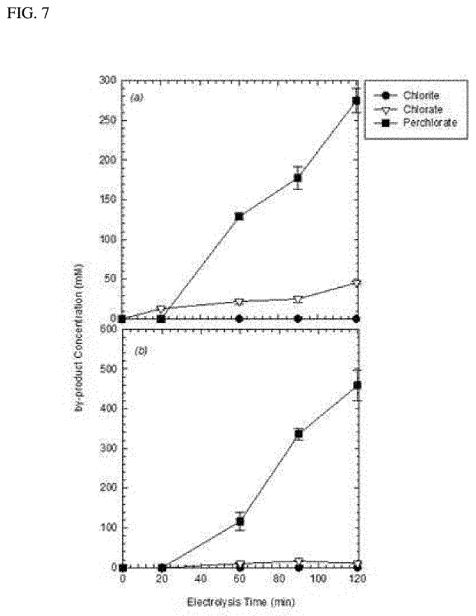

FIG. 7 is a graph showing the toxic by-products contained in the solution treated in the electrolytic bath. In FIG. 7, (a) is related to the electrolytic oxidation of ammonia solution for 120 minutes. It could be identified that as ammonia was completely decomposed, 270 mM of perchlorate as a chloride was produced. (b) in FIG. 7 is related to the electrolytic oxidation of ammonia/phenol solution for 120 minutes. It could be identified that while both ammonia and phenol were decomposed, 400 mM of perchlorate as a toxic by-product was produced.

4. Preparation of Activated Carbon of Deionization Bath

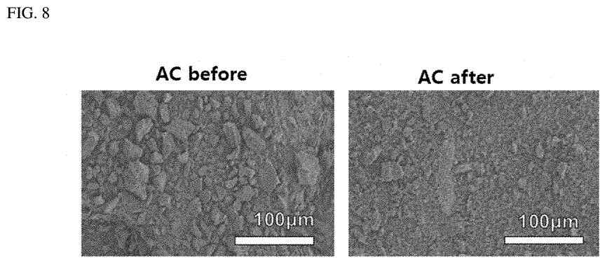

The activated carbon in the form of particles as an electrode in the deionization bath was prepared as follows. P-60 carbon particles were ultra-sonicated for 5 hours. Table 1 below indicates numerical values of the specific surface area of the activated carbon particle before and after ultrasonication. FIG. 8 is a photograph showing the activated carbon contained in the deionization bath according to the present example before and after ultrasonication. Referring to Table 1 and FIG. 8, it was identified that the specific surface area of activated carbon increases after the ultrasonication, and the particle sizes of the activated carbo became uniform after the ultrasonication.

TABLE 1

| | Before | After |
|---|---|---|
| | ultrasonication | ultrasonication |
| Specific surface area (BET) | 1328.8 m²/g | 1622.2 m²/g |

5. Evaluation of Ion Adsorption Capacity in Deionization Bath

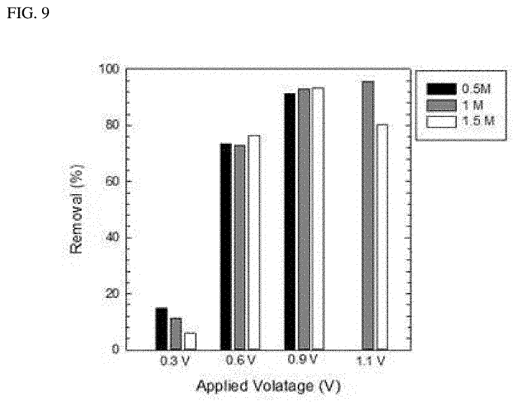

As described above, the sonicated activated carbon (AC) particles were used as the electrode in the flow-electrode capacitive deionization process in the deionization bath (FIG. 2). We added NaCl together with the activated carbon to the raw-water supply bath. Three types of electrolytes at concentrations of 0.5M, 1M and 1.5M were prepared. Each electrolyte was placed in the deionization bath. We applied each of 0.3V, 0.6V, 0.9V, and 1.1V thereto for 1 hour. We identified the removal rate of ions from the electrolyte, and desalination efficiency. FIG. 9 is a graph identifying the ion removal rate in the deionization bath.

Referring to FIG. 9, it could be identified that the ions in the electrolyte were effectively removed when 0.6V or higher was applied thereto. When considering the energy consumption, it could be identified that the most effective ion removal rate and desalination efficiency were exhibited at 0.9V and in 1M electrolyte.

6. Evaluation of Perchlorate Adsorption Capacity in Deionization Bath

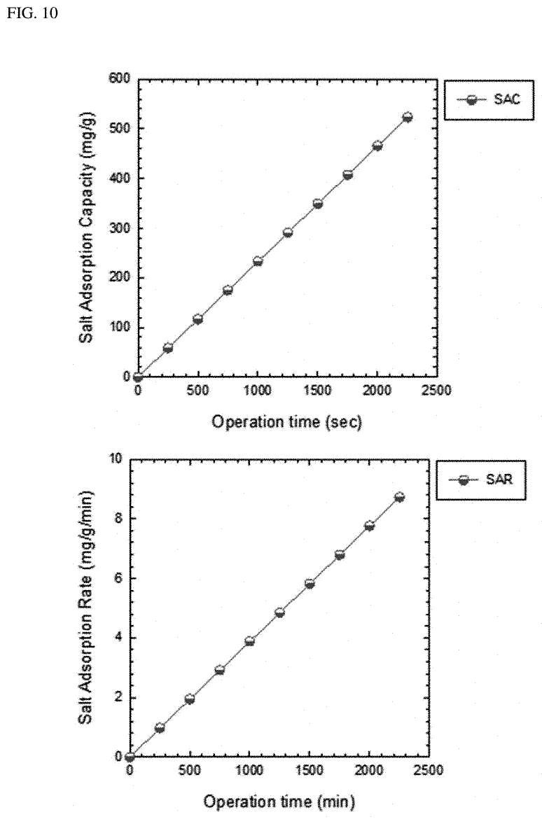

A solution of 500 mg/L concentration was prepared by adding perchloric acid in the raw-water supply bath. Using the prepared solution as the input water, the flow-electrode capacitive deionization FCDI was performed in the deionization bath (FIG. 2). The adsorption capacity of ions was evaluated. FIG. 10 is a graph showing the salt adsorption capacity and the salt adsorption rate in the deionization bath.

Referring to FIG. 10, it was identified that an ion removal efficiency of 74.6% was exhibited for 40 minutes. It was identified based on the salt adsorption capacity and the salt adsorption rate that the adsorption amount of perchlorate ions increased over time during the flow-electrode capacitive deionization process.

Although the embodiments of the present disclosure have been described in more detail with reference to the accompanying drawings, the present disclosure is not necessarily limited to these embodiments. The present disclosure may be implemented in various modified manners within the scope not departing from the technical idea of the present disclosure. Accordingly, the embodiments disclosed in the present disclosure are not intended to limit the technical idea of the present disclosure, but to describe the present disclosure. the scope of the technical idea of the present disclosure is not limited by the embodiments. Therefore, it should be understood that the embodiments as described above are illustrative and non-limiting in all respects. The scope of protection of the present disclosure should be interpreted by the claims, and all technical ideas within the scope of the present disclosure should be interpreted as being included in the scope of the present disclosure.

What is claimed is:

1. A hybrid water-treating system comprising:
a raw-water supply bath having a predetermined volume and configured to receive raw-water containing high concentration organic contaminants;
at least one electrolytic bath configured to receive the raw-water supplied from the raw-water supply bath and to produce first treated water, wherein a boron doped diamond (BDD) electrode is installed in the electrolytic bath; and
at least one deionization bath configured to receive the first treated water discharged from the electrolytic bath and to produce second treated water, wherein flow-electrode capacitive deionization (FCDI) is performed when applying a first voltage to the deionization bath.

2. The system of claim 1, wherein the system further comprises:
a first treated water connection channel for connecting the electrolytic bath and the deionization bath to each other, wherein a pump for delivering the first treated water is installed in the first treated water connection channel; and
a storage bath for receiving the second treated water from the deionization bath and storing the second treated water therein.

3. The system of claim 1, wherein the raw-water includes sea-water containing sodium chloride (NaCl) at a concentration of 0.3M to 1.0M, wherein the first treated water contains perchlorate at a first concentration,
wherein the second treated water contains perchlorate at a second concentration, wherein the second concentration is lower than or equal to 0.3 times of the first concentration.

4. The system of claim 1, wherein the first voltage is in a range of 0.6V to 1.2V.

5. The system of claim 1, wherein the deionization bath includes:
a negative electrode including activated carbon particles;
a positive electrode facing toward and spaced from the negative electrode; and
at least one ion exchange membrane disposed between the negative electrode and the positive electrode,
wherein the activated carbon particles have been subjected to ultrasonication for 3 to 10 hours,
wherein the activated carbon particle has a particle diameter of 1 μm to 150 μm, and a specific surface area of 1500 m²/g to 1600 m²/g.

6. The system of claim 5, wherein the negative electrode has a plate shape, and the positive electrode has a plate shape having a size corresponding to a size of the negative electrode,
wherein the at least one ion exchange membrane includes a first membrane adjacent to the positive electrode, and a second membrane adjacent to the negative electrode, and spaced apart from the first membrane,
wherein while the first treated water passes through a flow path defined between the first and second membranes, the first treated water is converted into the second treated water.

7. The system of claim 1, wherein the electrolytic bath further includes a counter electrode facing toward the boron doped diamond electrode, wherein the counter electrode is made of at least one of titanium (Ti), zirconium (Zr), or platinum (Pt).

8. The system of claim 1, wherein the system further comprises a power supply electrically connected to the deionization bath, wherein the power supply include a solar cell for collecting solar energy and converting the solar energy into electric energy, wherein the power supply supplies the electrical energy to the deionization bath.

9. The system of claim 1, wherein the raw-water includes sea-water, and the system is used for sea-water desalination.

10. A hybrid water-treating method comprising:
providing an electrolytic bath in which a boron doped diamond electrode is installed;
introducing raw-water containing red tide into the electrolytic bath;
applying a current to the electrode to produce first treated water;
delivering the first treated water to a deionization bath in which flow-electrode capacitive deionization (FCDI) is performed; and
applying a first voltage to the deionization bath to produce second treated water.

11. The method of claim 10, the raw-water includes sea-water containing sodium chloride (NaCl) at a concentration of 0.3 M to 1.0 M,
wherein the first treated water contains perchlorate at a first concentration,
wherein the second treated water contains perchlorate at a second concentration, wherein the second concentration is lower than or equal to 0.3 times of the first concentration.

12. The method of claim 10, wherein the first voltage is in a range of 0.6V to 1.2V.

13. The method of claim 10, wherein the deionization bath includes:
a negative electrode including activated carbon particles;
a positive electrode facing toward and spaced from the negative electrode; and
at least one ion exchange membrane disposed between the negative electrode and the positive electrode,
wherein the activated carbon particles have been subjected to ultrasonication for 3 to 10 hours,
wherein the activated carbon particle has a particle diameter of 1 μm to 150 μm, and a specific surface area of 1500 m²/g to 1600 m²/g.
